(19) United States
(12) Patent Application Publication
(10) Pub. No.: US 2025/0342439 A1
(43) Pub. Date: Nov. 6, 2025

(54) METHODS AND SYSTEMS FOR CREATING ARTIFICIAL INTELLIGENCE (AI) BASED PRODUCT GENEALOGY AND SUPPLIER DATA MAP

(71) Applicant: Honeywell International Inc., Charlotte, NC (US)

(72) Inventor: Varun Singh, Pune (IN)

(21) Appl. No.: 18/746,050

(22) Filed: Jun. 18, 2024

(30) Foreign Application Priority Data
May 2, 2024 (IN) 202411034786

(51) Int. Cl. G06Q 10/0875

(52) U.S. Cl. CPC G06Q 10/0875

(57) ABSTRACT

A method for artificial intelligence (AI) based generation of product genealogy and supplier data map is disclosed. The method comprises receiving a first set of data associated with one or more products over a predefined time period; training one or more artificial intelligence/machine learning (AI/ML) models based at least on first set of data; receiving a second set of data associated with one or more products in real-time; correlating each of first set of parameters of first set of data with corresponding second set of parameters of second set of data using one or more AI/ML models; predicting a third set of data associated with one or more products; generating a probability score for third set of data using one or more AI/ML models; and creating at least one supply chain map for one or more products based at least on third set of data.

### TECHNOLOGICAL FIELD

The present invention relates to a supply chain management, and more particularly relates to a method and system for creating artificial intelligence (AI) based product genealogy and supplier data map.

### BACKGROUND

In the domain of a supply chain management, mapping of multi-level genealogy data encompassing raw materials and sub-components of the raw materials, with supplier networks, has traditionally been a labor-intensive and error-prone task. Tracking and mapping the multi-level genealogy data relies heavily on manual processes and vast quantities of records. Such reliance on the manual processes and vast quantities of records has posed significant challenges, leading to inefficiencies, inaccuracies, and delays in decision-making in the supply chain management. Currently, there are no techniques available in the market that leverage data and artificial intelligence to reimagine the mapping of the multi-level genealogy data in the supply chain management without direct involvement of a supplier. Therefore, such techniques do not offer a solution to the industry-wide dilemma in the supply chain management by automating an intricate mapping of the multi-level genealogy data and supplier networks.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method is disclosed. The method comprises receiving, via at least one processor, a first set of data associated with one or more products over a predefined time period. The first set of data corresponds to a historical data of the one or more products having a first set of parameters. Further, the method comprises training, via the at least one processor, one or more artificial intelligence/machine learning (AI/ML) models based at least on the first set of data for the predefined time period. Further, the method comprises receiving, via the at least one processor, a second set of data associated with the one or more products in real-time. The second set of data corresponds to an input data of the one or more products having a second set of parameters. Further, the method comprises correlating, via the at least one processor, each of the first set of parameters of the first set of data with the corresponding second set of parameters of the second set of data using the trained one or more AI/ML models. Further, the method comprises predicting, via the at least one processor, a third set of data associated with the one or more products based at least on the correlation using the trained one or more AI/ML models. The third set of data corresponds to the correlated first set of data and the second set of data. Further, the method comprises generating, via the at least one processor, a probability score for the third set of data using the trained one or more AI/ML models. The third set of data comprises information related to the one or more products, a plurality of raw materials for each of the one or more products, and one or more suppliers for each of the plurality of raw materials across a supply chain. Thereafter, the method comprises creating, via the at least one processor, at least one supply chain map for the one or more products based at least on the third set of data using the trained one or more AI/ML models.

In some embodiments, the first set of parameters and the second set of parameters comprise at least one of quality report data, certification data, batch record data, shipment document data, of the one or more products and a plurality of raw materials for each of the one or more products. In some embodiments, the at least one quality report data comprises at least deviations and non-conformances, change control, complaints, recalls and returns, out of specification (OOS) and out of trend (OOT), corrective and preventive actions (CAPAs), self-inspection, stability, vendor assurance, validation and qualification, quality risk management, and contractual agreements of the one or more products. The at least one shipment document data comprises at least supplier information, raw material code, serialization, shipment information, and quality Information of the one or more products. The at least one batch record data comprises at least batch identification (ID), production date, serialization information, Stock Keeping Unit (SKU) Code, and batch information records of the one or more products.

In some embodiments, the predefined time period comprises at least one of hours, days, months, quarters, or years in which the first set of data and the second set of data are received.

In some embodiments, the one or more trained AI/ML models comprises at least a product raw material Stock Keeping Unit (SKU) tree AI/ML model, a supplier tree AI/ML model, a quality history AI/ML model, a certification tree and audit trail AI/ML model, and a batch traceability AI/ML model. The product raw SKU tree AI/ML model comprises one or more data corresponding to a plurality of raw materials for each of the one more products, the supplier tree AI/ML model comprises one or more data corresponding to supplier information for each of the plurality of raw materials, the quality history AI/ML model comprises one or more data corresponding to quality reports of each of the one or more products, the certification tree and audit trail AI/ML model comprises certification data of the one or more products, and the batch traceability AI/ML model comprises one or more data corresponding to batch records of the one or more products.

In some embodiments, the probability score corresponds to a percentage for the plurality of raw materials of each of the one or more products and the one or more suppliers for each of the plurality of raw materials across the supply chain.

In some embodiments, the method further comprising verifying, via the at least one processor, the probability score generated for the third set of data using the trained one or more AI/ML models, based at least on the first set of data and the second set of data.

In another example embodiment, a system is disclosed. The system comprises a memory and at least one processor is communicatively coupled to the memory. The at least one processor is configured to receive a first set of data associated with one or more products over a predefined time period. The first set of data corresponds to a historical data of one or more products having a first set of parameters. Further, the at least one processor is configured to train one or more artificial intelligence/machine learning (AI/ML) models based at least on the first set of data for the predefined time period. Further, the at least one processor is configured to receive a second set of data associated with the one or more products in real-time. The second set of data corresponds to an input data of the one or more products having a second set of parameters. Further, the at least one processor is configured to correlate each of the first set of parameters of the first set of data with the corresponding the second set of parameters of the second set of data using the trained one or more AI/ML models. Further, the at least one processor is configured to predict a third set of data associated with the one or more products based at least on the correlation, using the trained one or more AI/ML models. The third set of data corresponds to the correlated first set of data and the second set of data. Further, the at least one processor is configured to generate a probability score for the third set of data using the trained one or more AI/ML models. The third set of data comprises information related to the one or more products, a plurality of raw materials for each of the one or more products, and one or more suppliers for each of the plurality of raw materials across a supply chain. Thereafter, the at least one processor is configured to create at least one supply chain map for the one or more products based at least on the third set of data using the trained one or more AI/ML models.

In another example embodiment, a non-transitory machine-readable information storage medium is disclosed. The non-transitory machine-readable information storage medium comprising one or more instructions which when executed by at least one processor to perform operations comprising receiving a first set of data associated with one or more products over a predefined time period, wherein the first set of data corresponds to a historical data of the one or more products having a first set of parameters; training one or more artificial intelligence/machine learning (AI/ML) models based at least on the first set of data for the predefined time period; receiving a second set of data associated with the one or more products in real-time, wherein the second set of data corresponds to an input data of the one or more products having a second set of parameters; correlating each of the first set of parameters of the first set of data with the corresponding the second set of parameters of the second set of data using the trained one or more AI/ML models; predicting a third set of data associated with the one or more products based at least on the correlation using the trained one or more AI/ML models, wherein the third set of data corresponds to the correlated first set of data and the second set of data; generating a probability score for the third set of data using the trained one or more AI/ML models, wherein the third set of data comprises information related to the one or more products, a plurality of raw materials for each of the one or more products, and one or more suppliers for each of the plurality of raw materials across a supply chain; and creating at least one supply chain map for the one or more products based at least on the third set of data using the trained one or more AI/ML models.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRA WINGS

Having thus described certain example embodiments of the present disclosure in general terms, reference will hereinafter be made to the accompanying drawings, which are not necessarily drawn to scale, and wherein:

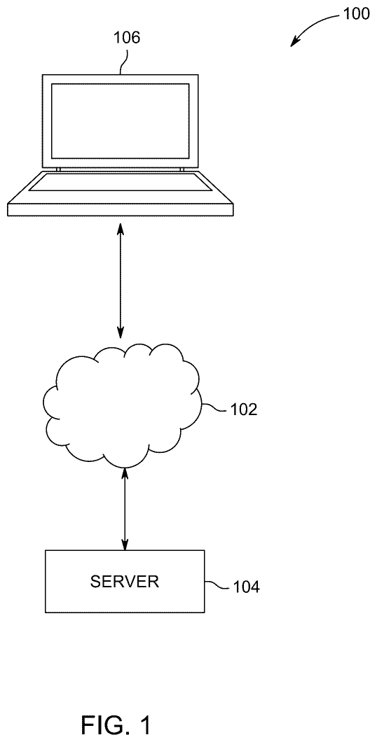

FIG. 1 illustrates a network diagram of a system for creating artificial intelligence (AI) based product genealogy and supplier data map in accordance with an example embodiment of the present disclosure;

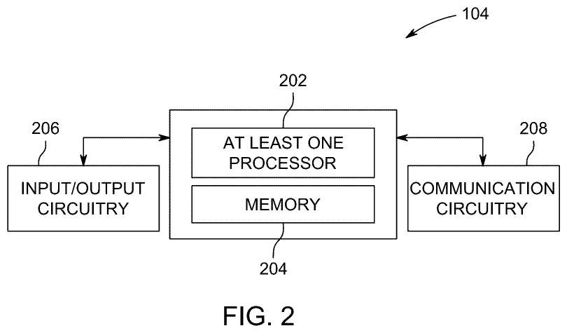

FIG. 2 illustrates a block diagram of a server in accordance with an example embodiment of the present disclosure;

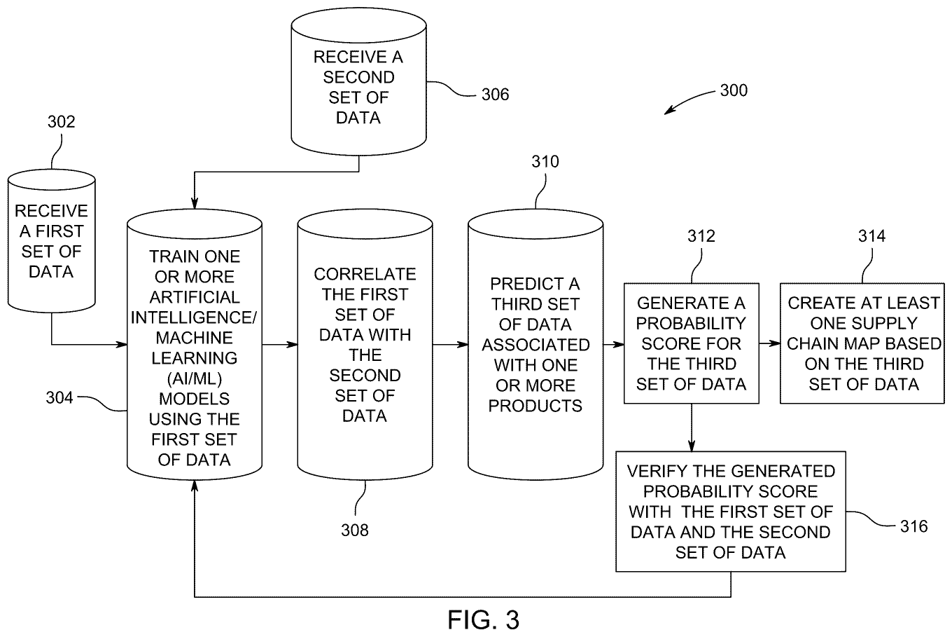

FIG. 3 illustrates a block diagram showing an operation of the system for creating AI based product genealogy and supplier data map in accordance with an example embodiment of the present disclosure;

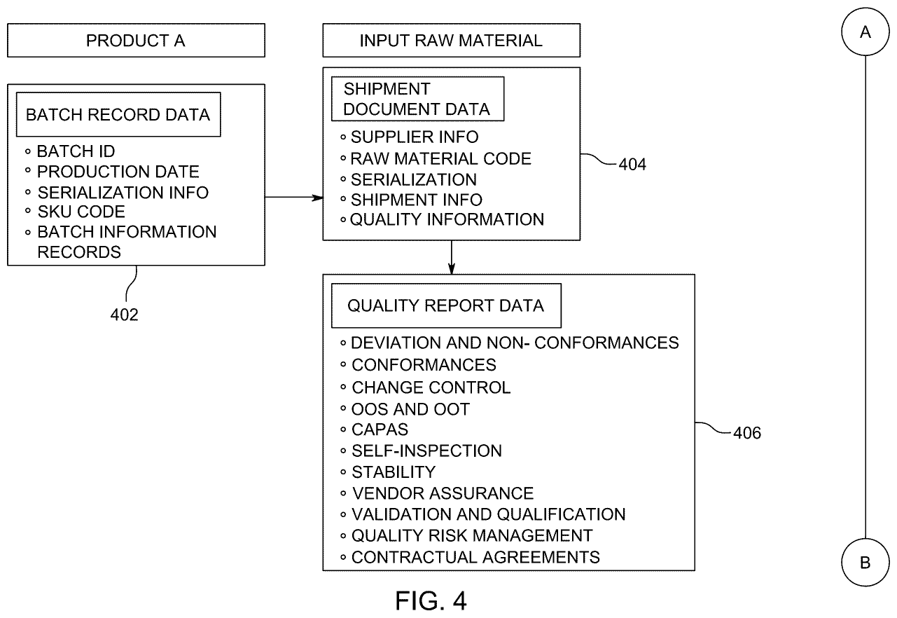

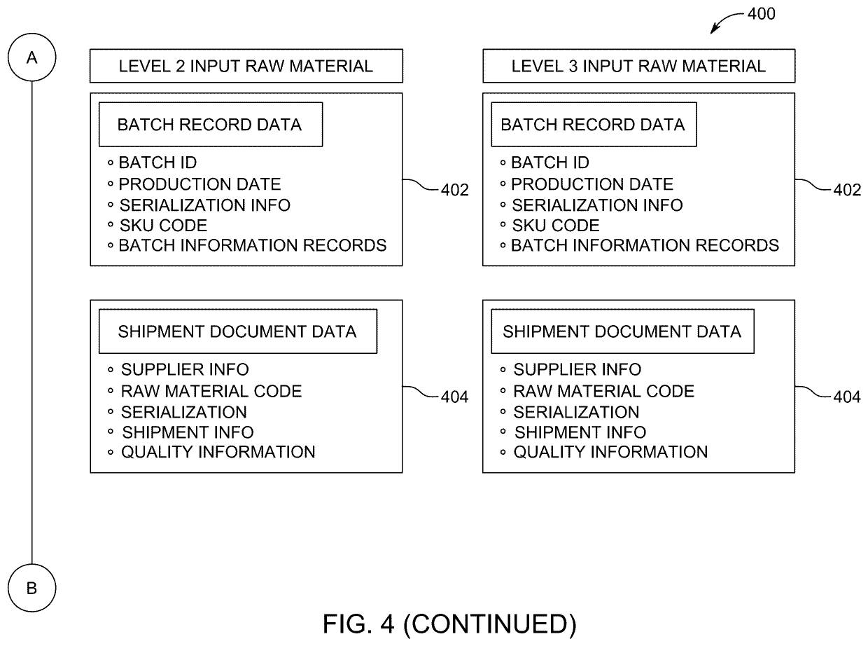

FIG. 4 illustrates a block diagram showing a first set of parameters of a first set of data across a supply chain in accordance with an example embodiment of the present disclosure;

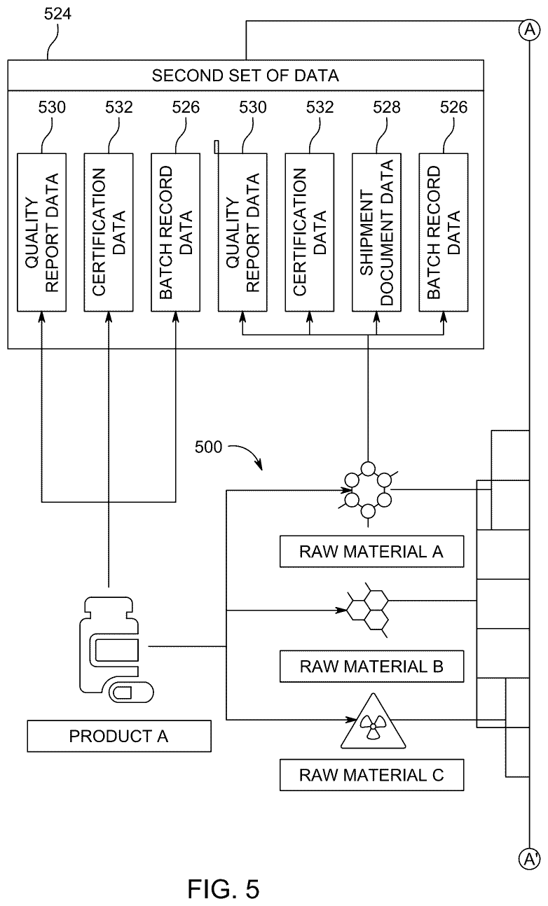

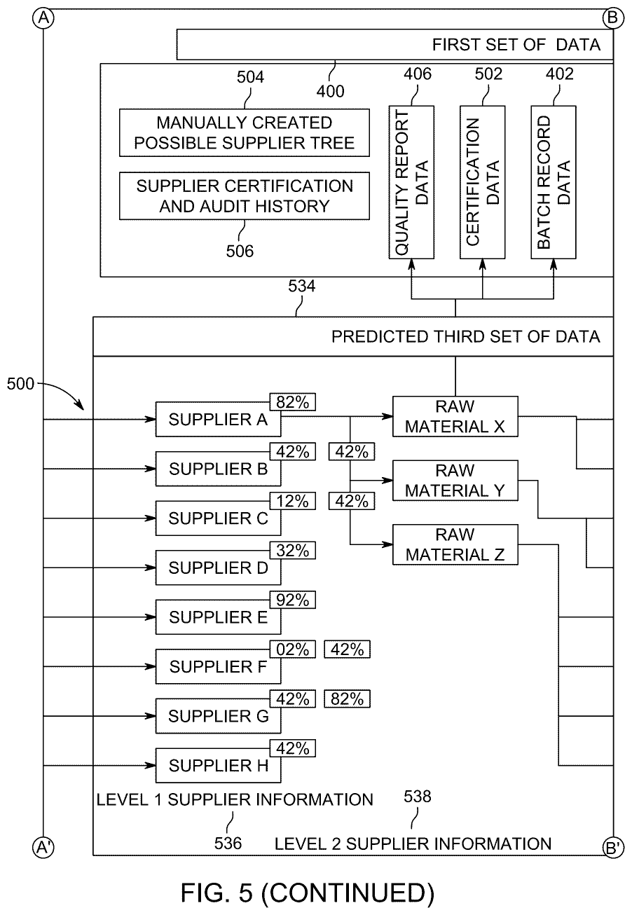

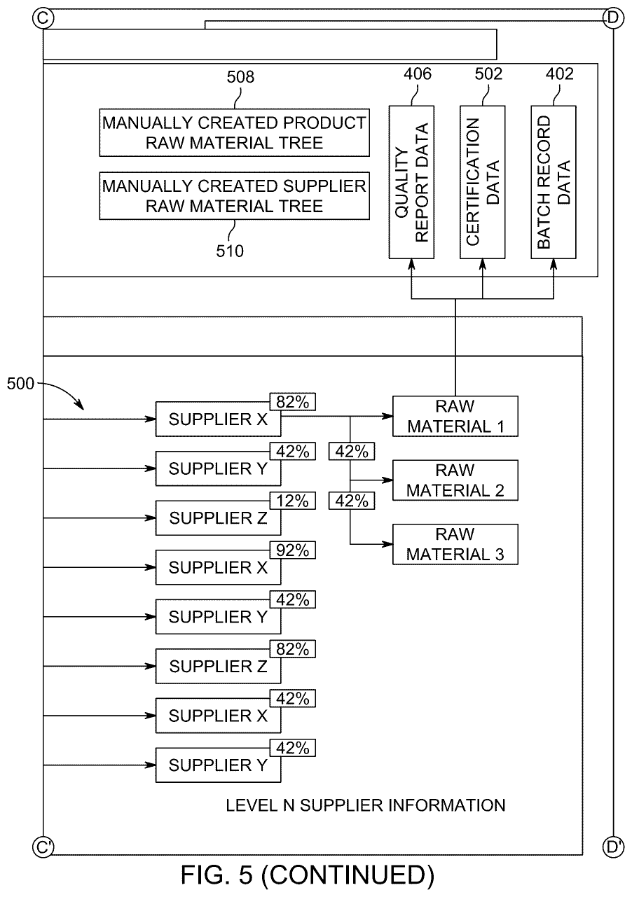

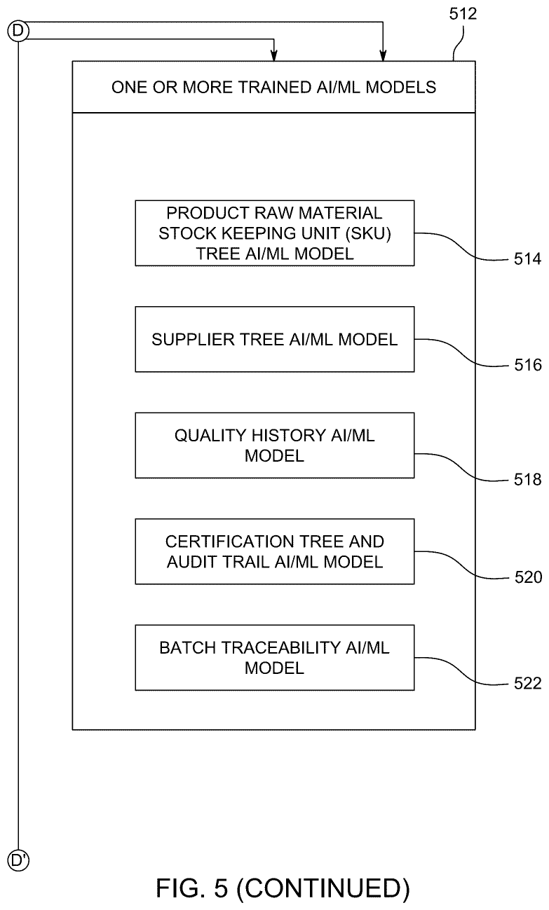

FIG. 5 illustrates at least one supply chain map for the one or more products generated by the system in accordance with an example embodiment of the present disclosure;

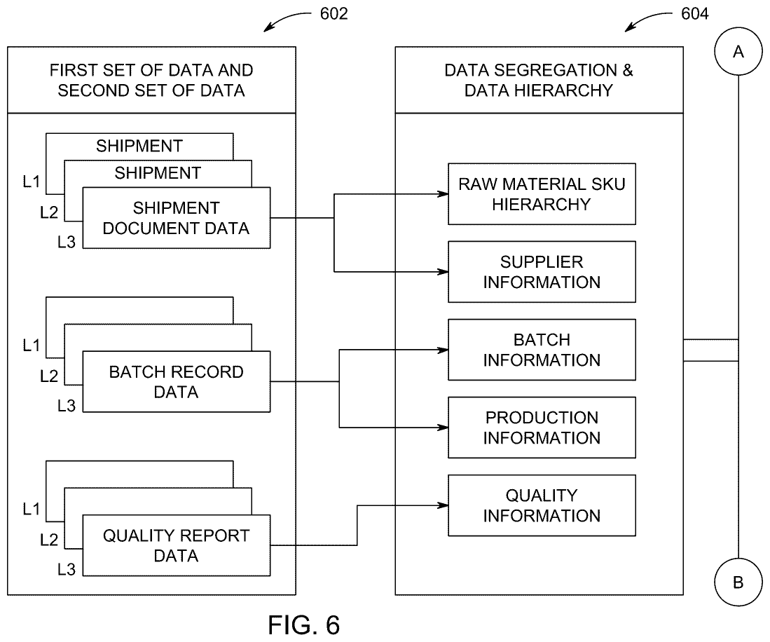

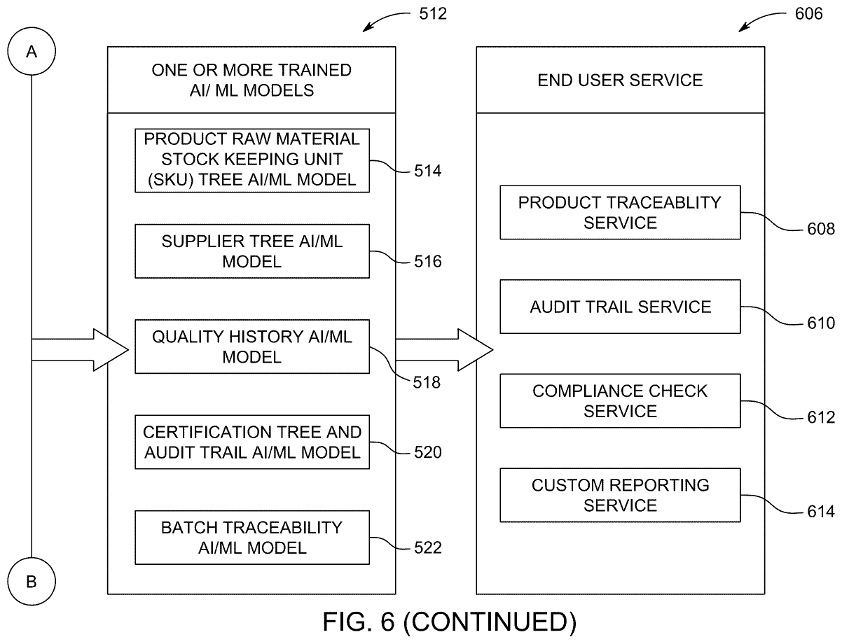

FIG. 6 illustrates one or more end user services provided by the operation of the system in accordance with an example embodiment of the present disclosure; and

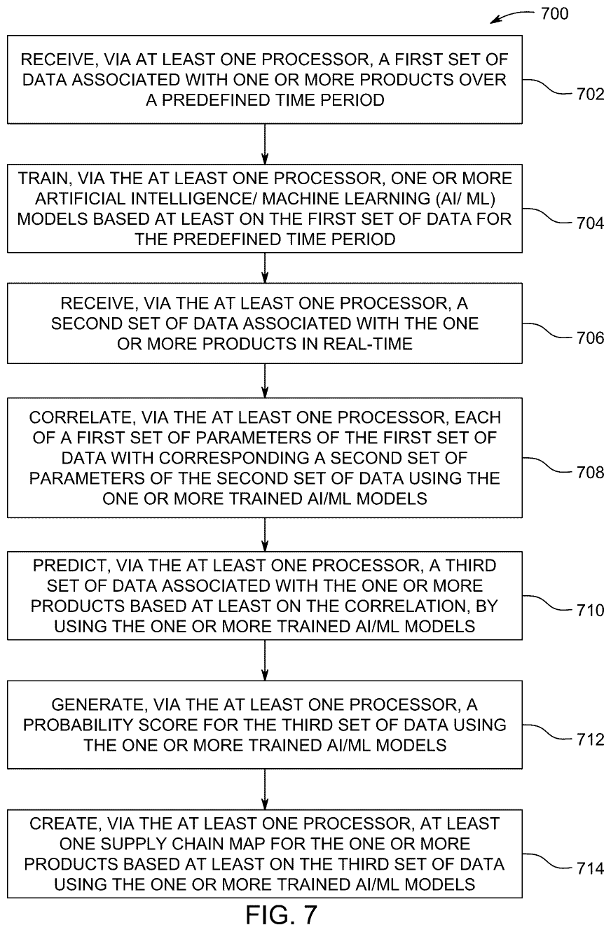

FIG. 7 illustrates a flowchart showing a method for creating artificial intelligence (AI) based product genealogy and supplier data map in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to raise and lower objects unless otherwise noted.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and system for artificial intelligence (AI) based generation of product genealogy and supplier data mapping. Embodiments may be configured to receive a first set of data associated with one or more products over a predefined time period. Embodiments may be configured to train one or more artificial intelligence/machine learning (AI/ML) models based at least on the first set of data for the predefined time period. Embodiments may be configured to receive a second set of data associated with the one or more products in real-time. Embodiments may be configured to correlate each of the first set of parameters of the first set of data with the corresponding the second set of parameters of the second set of data using the trained one or more AI/ML models. Embodiments may be configured to predict a third set of data associated with the one or more products based at least on the correlation, using the trained one or more AI/ML models. Embodiments may be configured to generate a probability score for the third set of data using the trained one or more AI/ML models. In some embodiments, the third set of data can comprise information related to the one or more products, a plurality of raw materials for each of the one or more products, and one or more suppliers for each of the plurality of raw materials across a supply chain. Embodiments may be configured to create at least one supply chain map for the one or more products based at least on the third set of data using the trained one or more AI/ML models.

FIG. 1 illustrates a network diagram of a system 100 for creating artificial intelligence (AI) based product genealogy and supplier data map in accordance with an example embodiment of the present disclosure. The system 100 may comprise a network 102 communicatively coupled to a server 104 and a user device 106.

In some embodiments, the network 102 may be a communication network such as internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

In some embodiments, the server 104 may be a computer or software module that is communicatively coupled with the network 102. In some embodiments, the server 104 may be configured to provide centralized resources, data, or services to the user device 106 operated by a user. The server 104 may be configured to handle and manage one or more computational tasks and data processing within the system 100. In some embodiments, the server 104 may include storage systems, such as hard drives or storage arrays, to store and manage large volumes of data and information accessible to network users. In some embodiments, the server 104 may further provide centralized control and management capabilities, allowing network administrators to configure, monitor, and maintain network resources, security settings, and user access permissions from a single location.

In some embodiments, the server 104 may be configured to receive a first set of data associated with one or more products over a predefined time period. In one example, the one or more products may be a medicine, an electronic device etc. for which the supply chain map is to be created for the user. The first set of data may correspond to a historical data of one or more products having a first set of parameters. In some embodiments, the server 104 may be configured to train one or more artificial intelligence/machine learning (AI/ML) models based at least on the first set of data for the predefined time period. In some embodiments, the server 104 may be configured to receive a second set of data associated with the one or more products in real-time. In some embodiments, the second set of data may correspond to an input data of the one or more products having a second set of parameters. In some embodiments, the server 104 may be configured to correlate each of the first set of parameters of the first set of data with the corresponding the second set of parameters of the second set of data using the trained one or more AI/ML models. In some embodiments, the server 104 may be configured to predict a third set of data associated with the one or more products based at least on the correlation, using the trained one or more AI/ML models. The third set of data may correspond to the correlated first set of data and the second set of data.

Further, the server 104 may be configured to generate a probability score for the third set of data using the trained one or more AI/ML models. In some embodiments, the third set of data may comprise information related to the one or more products, a plurality of raw materials for each of the one or more products, and one or more suppliers for each of the plurality of raw materials across a supply chain. In some embodiments, the server 104 may be configured to create at least one supply chain map for the one or more products based at least on the third set of data using the trained one or more AI/ML models.

In one example embodiment, the one or more AI/ML models may comprise of various types of AI/ML models tailored to different aspects of product genealogy and supplier data mapping. In some embodiments, the one or more AI/ML models may correspond to natural language processing (NLP), clustering or unsupervised learning, reinforcement learning (RL) or any other AI/ML models known in the art. For instance, supervised learning models such as decision trees, random forests, or neural networks may be utilized to train models based on the first set of data. The supervised learning models may learn patterns and relationships within first set of the data to make predictions about future product-related parameters.

Additionally, the unsupervised learning methods such as clustering algorithms may be employed to analyse complex datasets and identify groups or patterns within the first set of data and the second set of data. Furthermore, probabilistic models such as Bayesian networks may generate probability scores for the predicted third set of data, to provide insights into the likelihood of certain events occurring within the supply chain. Moreover, reinforcement learning method may optimize decision-making processes over time, to continuously improve the performance of the system 100 in managing the at least one supply chain map. The one or more AI/ML models may enable the server 104 to provide comprehensive analysis and prediction capabilities essential for effective supply chain management.

In some embodiments, the server 104 may further be configured to send the created at least one supply chain map for the one or more products to the user device 106. The user device 106 may be equipped by a manager of a warehouse or other service professionals responsible for addressing and reacting to the changes in supply chain of the one or more products. In some embodiments, the created at least one supply chain map by the server 104 may provide a summarized data to the user that is easy to understand. In some embodiments, the user device 106 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

FIG. 2 illustrates a block diagram of the server 104 in accordance with an example embodiment of the present disclosure. FIG. 3 illustrates a block diagram showing an operation 300 of the system 100 in accordance with an example embodiment of the present disclosure. FIG. 4 illustrates a block diagram showing a first set of parameters of a first set of data 400 across a supply chain in accordance with an example embodiment of the present disclosure. FIG. 5 illustrates at least one supply chain map 500 for the one or more products generated by the system 100 in accordance with an example embodiment of the present disclosure. FIGS. 2-5 are described in conjunction with FIG. 1.

The server 104 may comprise at least one processor 202, a memory 204, an input/output circuitry 206, and a communication circuitry 208. In some embodiments, the at least one processor 202 may be configured to receive the first set of data 400 associated with the one or more products over the predefined time period, as illustrated by 302, in FIG. 3. The first set of data 400 may correspond to the historical data of one or more products having the first set of parameters. The first set of parameters may comprise at least one of the batch record data 402, the shipment document data 404, the quality report data 406 of the one or more products and the plurality of raw materials for each of the one or more products across the supply chain for L1, L2, and L3, as illustrated in FIG. 4.

Further, the first set of parameters may comprise certification data 502 of the one or more products and the plurality of raw materials for each of the one or more products, as illustrated in FIG. 5. The predefined time period may comprise at least one of hours, days, months, quarters, or years in which the first set of data 400 is received. In some embodiments, the first set of data 400 may further comprise manually created possible supplier tree 504, supplier certification and audit history 506, manually created product raw material tree 508, and manually created supplier raw material tree 510, as illustrated in FIG. 5. In some embodiments, the manually created possible supplier tree 504 may correspond to a visual representation of potential suppliers and the relationships of the potential suppliers for the manufacturing of the product A. In some embodiments, the supplier certification and audit history 506 may correspond to records detailing the certification status and audit findings of suppliers for the manufacturing of product A. In some embodiments, the manually created product raw material tree 508 may correspond to a visual hierarchy showing the plurality of raw materials used in manufacturing of product A. In some embodiments, the manually created supplier raw material tree 510 may correspond to a visual representation of the plurality of raw materials sourced by a plurality of suppliers for the manufacturing of product A.

In one example embodiment, the at least one processor 202 may be configured to receive a first set of data 400 spanning historical data of diverse product portfolio of a product A. The first set of data 400 may encompass the batch record data 402, the shipment document data 404, the quality report data 406, and the certification data 502, along with detailed information on the plurality of raw materials for manufacturing the product A. The detailed information on the plurality of raw materials for manufacturing the product A may comprise historical data on L2 input raw material required to manufacture the plurality of raw materials, and historical data on L3 input raw material required to manufacture the L2 input raw material.

In some embodiments, the at least one processor 202 may be configured to train one or more artificial intelligence/machine learning (AI/ML) models 512, as illustrated in FIG. 5. Further, the one or more AI/ML models 512 may be trained, based at least on the first set of data 400 for the predefined time period, as illustrated by 304, in FIG. 3. In some embodiments, the one or more AI/ML models 512 may be based at least on one of known AI/ML techniques such as XGBoost, Artificial Neural Networks or any other known AI/ML techniques known in the art. Further, the trained one or more AI/ML models 512 may comprise at least a product raw material Stock Keeping Unit (SKU) tree AI/ML model 514, a supplier tree AI/ML model 516, a quality history AI/ML model 518, a certification tree and audit trail AI/ML model 520, and a batch traceability AI/ML model 522.

In some embodiments, the product raw material SKU tree AI/ML model 514 may comprise one or more data corresponding to the plurality of raw materials for each of the one more products. In some embodiments, the supplier tree AI/ML model 516 may comprise one or more data corresponding to a supplier information for each of the plurality of raw materials. In some embodiments, the quality history AI/ML model 518 may comprise one or more data corresponding to quality report data 406 of each of the one or more products. In some embodiments, the certification tree and audit trail AI/ML model 520 may comprise the certification data 502 of the one or more products. In some embodiments, the batch traceability AI/ML model 522 may comprise one or more data corresponding to batch record data 402 of the one or more products. In one example embodiment, the at least one processor 202 may be configured to train the one or more AI/ML models 512 including the product raw material SKU tree AI/ML model 514, the supplier tree AI/ML model 516, the quality history AI/ML model 518, the certification tree and audit trail AI/ML model 520, and the batch traceability AI/ML model 522 for the product A.

In some embodiments, the at least one processor 202 may be configured to receive a second set of data 524 associated with the one or more products in real-time, as illustrated by 306, in FIG. 3. The second set of data 524 may correspond to the input data of the one or more products having a second set of parameters. In one example embodiment, the second set of data 524 may correspond to an input data from manufacturer of product A. Further, the second set of parameters may comprise at least one of batch record data 526, shipment document data 528, quality report data 530, and certification data 532 of the one or more products and the plurality of raw materials for each of the one or more products. In some embodiments, the at least one batch record data 526 of the second set of data 524 may comprise at least batch identification (ID), production date, serialization information, Stock Keeping Unit (SKU) Code, and batch information records of the one or more products.

In some embodiments, the shipment document data 528 of the second set of data 524 may comprise at least supplier information, raw material code, serialization, shipment information, and quality Information of the one or more products. In some embodiments, the quality report data 530 of the second set of data 524 may comprise at least deviations and non-conformances, change control, complaints, recalls and returns, out of specification (OOS) and out of trend (OOT), corrective and preventive actions (CAPAs), self-inspection, stability, vendor assurance, validation and qualification, quality risk management, and contractual agreements of the one or more products. In one example embodiment, the at least one processor 202 may be configured to receive the second set of data 524 associated with the ongoing product activities of the product A. For example, a user may enter details of the product A that is manufactured within a batch number (B1-B2). The user requires to identify the genealogy data for the product A manufactured in the batch number (B1-B2). The second set of data 524 may be received at regular intervals, and may include updated the batch record data 526, the shipment document data 528, the quality report data 530, and the certification data 532.

In some embodiments, the at least one processor 202 may be configured to correlate each of the first set of parameters of the first set of data 400 with the corresponding the second set of parameters of the second set of data 524 using the trained one or more AI/ML models 512, as illustrated by 308, in FIG. 3. Further, the at least one processor 202 may be configured to correlate the first set of parameters from the first set of data 400 with the second set of parameters from the second set of data 524 using the trained one or more AI/ML models 512, that enables proactive identification of potential issues or deviations in the supply chain. The at least one processor 202 may be configured to correlate the quality report data 406, the certification data 502, batch record data 402, shipment document data 404, of the one or more products and the plurality of raw materials for each of the one or more products, from the first set of data 400 with the quality report data 530, the certification data 532, the batch record data 526, the shipment document data 528, of the one or more products and the plurality of raw materials for each of the one or more products from the second set of data 524.

In some embodiments, the at least one processor 202 may be configured to correlate the information within the quality report data 406 for the first set of parameters with the information within the quality report data 530 for the second set of parameters. In some embodiments, the at least one processor 202 may be configured to correlate the information within the certification data 502 for the first set of parameters with the information within the certification data 532 for the second set of parameters. In some embodiments, the at least one processor 202 may be configured to correlate the information within the batch record data 402 for the first set of parameters with the information within the batch record data 526 for the second set of parameters. In some embodiments, the at least one processor 202 may be configured to correlate the information within the shipment document data 404 for the first set of parameters with the information within the shipment document data 528 for the second set of parameters. The correlation may help to obtain the relation between data of the product A and the plurality of raw materials.

Further, the at least one processor 202 may be configured to predict a third set of data 534 associated with the one or more products based at least on the correlation, using the trained one or more AI/ML models 512, as illustrated by 310, in FIG. 3. The third set of data 534 may correspond to the correlated first set of data 400 and the second set of data 524. In one example embodiment, the at least one processor 202 may be configured to predict the third set of data 534, combining correlated first set of data 400 and the second set of data 524. In one example, the third set of data 534 may provide detailed insights of the product A manufactured in the batch number (B1-B2), raw materials, and suppliers across the entire supply chain. Utilizing the third set of data 534 information, the at least one processor 202 may create the at least one supply chain map 500 across the supply chain of Level 1, Level 2, and up to Level n, illustrating the flow of materials and suppliers, facilitating transparency and efficiency in supply chain management.

For example, the product A utilizes at least three raw materials for manufacturing that is raw material A, raw material B and raw material C. Further, the raw material A procures raw materials from supplier A, supplier B and supplier C in Level 1 supply chain. Similarly, the raw material B procures raw materials from supplier B, supplier C, supplier D, supplier E, supplier F and supplier G in Level 1 supply chain. Further, the raw material C is procured from supplier F and supplier G and supplier H.

In some embodiments, the at least one processor 202 may be configured to generate the probability score for the third set of data 534 using the trained one or more AI/ML models 512, as illustrated by 312, in FIG. 3. The third set of data 534 may comprise information related to the one or more products, the plurality of raw materials for each of the one or more products, and one or more suppliers for each of the plurality of raw materials across the supply chain. Referring to FIG. 5, the at least one processor 202 may be configured to generate probability scores for each raw material and supplier involved in the supply chain of the product A. For example, the probability score of 82% for supplier A, 42% for supplier B, 12% for supplier C may be generated in Level 1 supplier information 536. Further, the at least one processor 202 may generate probability scores for the suppliers of the supplier A, i.e., 82% for supplier X, 42% for supplier Y and 12% for supplier Z in Level 2 supplier information 538. Further, the at least one processor 202 may generate the probability score of 82% for supplier A which indicates that for the product A, the chances of the supplier A providing the raw materials to be used to manufacture the product A is maximum from a list of suppliers A, B, and C. The generated probability score, presented as percentages, may highlight the likelihood of quality issues or disruptions at various stages, and the details of the product A at various stages of the supply chain.

Thereafter, the at least one processor 202 may be configured to create the at least one supply chain map 500 for the one or more products based at least on the third set of data 534 using trained one or more AI/ML models 512, as illustrated by 314, in FIG. 3. The at least one processor 202 may be configured to create the at least one supply chain map 500 illustrating the flow of materials and suppliers, facilitating transparency and efficiency in supply chain management, based at least on the third set of data 534. In one example embodiment, the at least one processor 202 may be configured to generate at least one supply chain map 500 based on generated probability score of 82% for supplier A, 42% for supplier B, 12% for supplier C in Level 1 supplier information 536, generated probability scores for the suppliers of the supplier A, i.e., 82% for supplier X, 42% for supplier Y and 12% for supplier Z in Level 2 supplier information 538, and generated probability score of 82% for supplier A which indicates that for the product A, the chances of the supplier A providing the raw materials to be used to manufacture the product A is maximum from a list of suppliers A, B, and C.

In some embodiments, the at least one processor 202 may be configured to verify the predicted probability score generated for the third set of data 534 using the trained one or more AI/ML models 512, based at least on the first set of data 400 and the second set of data 524, as illustrated by 316, in FIG. 3. The probability score may correspond to the percentage for the plurality of raw materials of each of the one or more products and the one or more suppliers for each of the plurality of raw materials across the supply chain.

The at least one processor 202 may include suitable logic, circuitry, and/or interfaces that are operable to execute one or more instructions stored in the memory 204 to perform predetermined operations. In one embodiment, the at least one processor 202 may be configured to decode and execute any instructions received from one or more other electronic devices or server(s). The at least one processor 202 may be configured to execute one or more computer-readable program instructions, such as program instructions to carry out any of the functions described in this description. Examples of the at least one processor 116 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 204 may be configured to store a set of instructions and data executed by the at least one processor 202. Further, the memory 204 may include the one or more instructions that are executable by the at least one processor 202 to perform specific operations. The memory 204 may be configured to include the instructions to receive a first set of data 400 associated with one or more products over the predefined time period. The memory 204 may be configured to include the instructions to train the one or more AI/ML models 512 based at least on the first set of data 400 for the predefined time period. Further, the memory 204 may be configured to include the instructions to receive the second set of data 524 associated with the one or more products in real-time. The memory 204 may be configured to include the instructions to correlate each of the first set of parameters of the first set of data 400 with the corresponding the second set of parameters of the second set of data 524 using the trained one or more AI/ML models 512.

The memory 204 may be configured to include the instructions to predict a third set of data 534 associated with the one or more products based at least on the correlation, using the trained one or more AI/ML models 512. The memory 204 may be configured to include the instructions to generate a probability score for the third set of data 534 using the trained one or more AI/ML models 512. It is apparent to a person with ordinary skill in the art that the one or more instructions stored in the memory 204 enable the hardware of the server 104 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 104 may further comprise the input/output circuitry 206. The input/output circuitry 206 may enable a user to communicate or interface with the server 104, via the user device 106. The user device 106 may include N number of user devices. In some embodiments, the input/output circuitry 206 may act as a medium to transmit input from the interface to and from the server 104. In some embodiments, the input/output circuitry 206 may refer to the hardware and software components that facilitate the exchange of information between user device 106 and the server 104. In one example, the user device 106 may include a graphical user interface (GUI) (not shown) as input circuitry to allow the one or more users to input the first set of data 400. The input/output circuitry 206 may include various input devices such as keyboards, barcode scanners, GUI for the one or more users to provide data and various output devices such as displays, printers for the one or more users to receive data. In another example, the input/output circuitry 206 may include various output circuitry such as a display to show the generated probability score.

In some embodiments, the server 104 may further comprise the communication circuitry 208. The communication circuitry 208 may allow the server 104 to exchange data or information with other systems or apparatuses. Further, the communication circuitry 208 may include network interfaces, protocols, and software modules responsible for sending and receiving data or information. In some embodiments, the communication circuitry 208 may include Ethernet ports, Wi-Fi adapters, or communication protocols like HTTP or MQTT for connecting with other systems. The communication circuitry 208 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 208 may allow the server 104 to stay up-to-date and accurately track the generated probability.

It will be apparent to one skilled in the art the above-mentioned components of the server 104 have been provided only for illustration purposes, without departing from the scope of the disclosure.

FIG. 6 illustrates a block diagram showing at least one end user service provided by the system 100. FIG. 6 is described in conjunction with FIGS. 1-5.

As discussed above in FIGS. 1-5, the at least one processor 202 may be configured to receive the first set of data 400 and the second set of data 524 across the supply chain, as illustrated by 602. In some embodiments, the first set of data 400 and the second set of data 524 comprises the first set of parameters and the second set of parameters. The first set of parameters may comprise at least one of the batch record data 402, the shipment document data 404, the quality report data 406 of the one or more products and the plurality of raw materials for each of the one or more products across the supply chain for L1, L2 and L3. The second set of parameters comprise at least one of batch record data 526, the shipment document data 528, the quality report data 530, and the certification data 532 of the one or more products and the plurality of raw materials for each of the one or more products across the supply chain for L1, L2, and L3.

Further, the at least one processor 202 may be configured to predict the third set of data 534 associated with the one or more products based at least on the correlation of the first set of data 400 and the second set of data 524. The correlation may provide information on data segregation and data hierarchy of the product A, as illustrated by 604. In one example embodiment, the information on data segregation and data hierarchy may comprise raw material SKU Hierarchy, supplier information, batch information, production information, and quality information of each of the one or more products.

Further, the at least one processor 202 may be configured to generate the probability score for the third set of data 534 using the trained one or more AI/ML models 512. The third set of data 534 may comprise information related to the one or more products, the plurality of raw materials for each of the one or more products, and one or more suppliers for each of the plurality of raw materials across the supply chain. Further, the at least one processor 202 may be configured to create the at least one supply chain map 500 for the one or more products based at least on the third set of data 534 using the trained one or more AI/ML models 512. Thereafter, the at least one processor 202 may be configured to provide at least one end user service, as illustrated by 606. The at least one end user service as illustrated by 606 may comprise at least one product traceability service 608 across the trained one or more AI/ML models 512, an audit trail service 610, a compliance check service 612, and a custom reporting service 614 for each of the one or more products.

In some embodiments, the product traceability service 608 across the trained one or more AI/ML models 512 may involve a systematic tracking of one or more products through various stages of production, distribution, and consumption using one of known AI/ML techniques. The trained one or more AI/ML models 512 may include the product raw material SKU tree AI/ML model 514 that may trace the origins and movements of the plurality of raw materials used in manufacturing of one or more products. Further, the trained one or more AI/ML models 512 may include the supplier tree AI/ML model 516 that may map the network of suppliers involved in sourcing components or ingredients. Further, the trained one or more AI/ML models 512 may include the quality history AI/ML model 518 that may analyse historical data to assess one or more products quality over time. Further, the trained one or more AI/ML models 512 may include the certification tree and audit trail AI/ML model 520 that may ensure compliance with regulatory standards and maintains a comprehensive audit trail of certifications and related actions. Further, the trained one or more AI/ML models 512 may include the batch traceability AI/ML model 522 that may track the movement of specific batches or lots of one or more products throughout the supply chain.

In some embodiments, the audit trail service 610 may provide detailed documentation of every action taken within the system 100, offering transparency and accountability by recording user interactions, the system 100 changes, and data modifications. In some embodiments, the compliance check service 612 may verify adherence to industry regulations, standards, and internal policies throughout the one or more products lifecycle, helping organizations mitigate risks and ensure regulatory compliance. In some embodiments, the custom reporting service 614 may generate tailored reports for each of the one or more products, offering insights into each of the one or more products traceability, quality, compliance status, and other relevant metrics, thereby enabling informed decision-making and continuous improvement efforts.

FIG. 7 illustrates a flowchart showing a method 700 for creating AI based product genealogy and supplier data map, in accordance with an example embodiment of the present disclosure. FIG. 7 is described in conjunction with FIGS. 1-6.

At operation 702, the at least one processor 202 may be configured to receive the first set of data 400 associated with one or more products over the predefined time period. The first set of data 400 may correspond to the historical data of one or more products having a first set of parameters. The first set of parameters may comprise at least one of quality report data 406, certification data 502, batch record data 402, shipment document data 404, of the one or more products and the plurality of raw materials for each of the one or more products. The predefined time period may comprise at least one of hours, days, months, quarters, or years in which the first set of data 400 and the second set of data 524 are received.

For example, the at least one processor 202 receives a first set of data 400 spanning historical records of diverse product portfolio of a paracetamol tablet. The first set of data 400 encompasses the quality report data 406, the certification data 502, batch record data 402, and shipment document data 404, along with detailed information on raw materials for manufacturing the paracetamol tablet. The first set of parameters within the first set of data 400 encompass deviations, complaints, production dates, serialization, and supplier details.

At operation 704, the at least one processor 202 may be configured to train the one or more AI/ML models 512 based at least on the first set of data 400 for the predefined time period. The trained one or more AI/ML models 512 may comprise at least the product raw material SKU tree AI/ML model 514, the supplier tree AI/ML model 516, the quality history AI/ML model 518, the certification tree and audit trail AI/ML model 520, and the batch traceability AI/ML model 522. For example, the at least one processor 202 trains the one or more AI/ML models 512 including the product raw material SKU tree AI/ML model 514, the supplier tree AI/ML model 516, the quality history AI/ML model 518, the certification tree and audit trail AI/ML model 520, and the batch traceability AI/ML model 522 for the paracetamol tablet.

At operation 706, the at least one processor 202 may be configured to receive the second set of data 524 associated with the one or more products in real-time. The second set of data 524 may correspond to the input data of the one or more products having the second set of parameters. The second set of parameters may comprise the quality report data 530, the certification data 532, batch record data 526, the shipment document data 528, of the one or more products and the plurality of raw materials for each of the one or more products. In some embodiments, the report data 530 may comprise at least deviations and non-conformances, change control, complaints, recalls and returns, out of specification (OOS) and out of trend (OOT), corrective and preventive actions (CAPAs), self-inspection, stability, vendor assurance, validation and qualification, quality risk management, and contractual agreements of the one or more products. In some embodiments, the shipment document data 528 may comprise at least supplier information, raw material code, serialization, shipment information, and quality Information of the one or more products. In some embodiments, the at least one batch record data 526 may comprise at least batch identification (ID), production date, serialization information, Stock Keeping Unit (SKU) Code, and batch information records of the one or more products.

For example, the at least one processor 202 receives the second set of data 524 associated with the ongoing product activities of the paracetamol tablet. For example, a user enters details of the paracetamol tablet that is manufactured within a batch number (B1-B2). The user requires to identify the genealogy data for the paracetamol tabled manufactured in the batch number (B1-B2). The second set of data 524 received at regular intervals, includes updated the quality report data 530, batch record data 526, and the shipment document data 528.

At operation 708, the at least one processor 202 may be configured to correlate each of the first set of parameters of the first set of data 400 with the corresponding the second set of parameters of the second set of data 524 using the trained one or more AI/ML models 512. The trained one or more AI/ML models 512 may comprise at least the product raw material SKU tree AI/ML model 514, the supplier tree AI/ML model 516, the quality history AI/ML model 518, the certification tree and audit trail AI/ML model 520, and the batch traceability AI/ML model 522. In some embodiments, the product raw SKU tree AI/ML model 514 may comprise one or more data corresponding to the plurality of raw materials for each of the one more products. In some embodiments, the supplier tree AI/ML model 516 may comprise one or more data corresponding to a supplier information for each of the plurality of raw materials. In some embodiments, the quality history AI/ML model 518 may comprise one or more data corresponding to quality reports of each of the one or more products. In some embodiments, the certification tree and audit trail AI/ML model 520 may comprise the certification data 502 of the one or more products. In some embodiments, the batch traceability AI/ML model 522 may comprise one or more data corresponding to batch records of the one or more products.

For example, the at least one processor 202 correlates the first set of parameters from the first set of data 400 with the second set of parameters from the second set of data 524 using the trained one or more AI/ML models 512, that enables proactive identification of potential issues or deviations in the supply chain.

At operation 710, the at least one processor 202 may be configured to predict the third set of data 534 associated with the one or more products based at least on the correlation, using the trained one or more AI/ML models 512. The third set of data 534 may correspond to the correlated first set of data 400 and the second set of data 524. For example, the at least one processor 202 predicts a third set of data 534, combining correlated first set of data 400 and the second set of data 524. The third set of data 534 provides detailed insights into the details of the paracetamol tablet manufactured in the batch number (B1-B2), raw materials, and suppliers across the entire supply chain. Utilizing the third set of data 534 information, the at least one processor 202 may create intricate maps illustrating the flow of materials and suppliers, facilitating transparency and efficiency in supply chain management.

At operation 712, the at least one processor 202 may be configured to generate a probability score for the third set of data 534 using the trained one or more AI/ML models 512. The third set of data 534 may comprise information related to the one or more products, the plurality of raw materials for each of the one or more products, and one or more suppliers for each of the plurality of raw materials across the supply chain. The probability score may correspond to the percentage for the plurality of raw materials of each of the one or more products and the one or more suppliers for each of the plurality of raw materials across the supply chain. For example, the at least one processor 202 generates probability scores for each raw material and supplier involved in the supply chain. The generated probability score, presented as percentages, highlight the likelihood of quality issues or disruptions at various stages, and the details of the product A at various stages of the supply chain.

At operation 714, the at least one processor 202 may be configured to the create at least one supply chain map 500 for the one or more products based at least on the third set of data 534 using the trained one or more AI/ML models 512. For example, the at least one processor 202 generates a supply chain map 500 based on generated probability score of 82% for supplier A, 42% for supplier B, 12% for supplier C in Level 1 supplier information 536. Further, the at least one processor 202 generates probability scores for the suppliers of the supplier A, i.e., 82% for supplier X, 42% for supplier Y and 12% for supplier Z in Level 2 supplier information 538. Further, the at least one processor 202 generates the probability score of 82% for supplier A which indicates that for the product A, the chances of the supplier A providing the raw materials to be used to manufacture the product A is maximum from a list of suppliers A, B, and C.

In some embodiments, the method 700 may further comprise verifying, via the at least one processor 202, the probability score generated for the third set of data 534 using the trained one or more AI/ML models 512, based at least on the first set of data 400 and the second set of data 524.

In some embodiments, the system 100 may comprise at least non-transitory machine-readable information storage medium comprising one or more instructions which when executed by the at least one processor 202 to perform operations comprising receiving the first set of data 400 associated with one or more products over the predefined time period. The first set of data 400 may correspond to the historical data of the one or more products having the first set of parameters. Further, the operations may comprise training one or more AI/ML models 512 based at least on the first set of data 400 for the predefined time period. In some embodiments, the trained one or more AI/ML models 512 may comprise at least the product raw material SKU tree AI/ML model 514, the supplier tree AI/ML model 516, the quality history AI/ML model 518, the certification tree and audit trail AI/ML model 520, and the batch traceability AI/ML model 522. Further, the operations may comprise receiving the second set of data 524 associated with the one or more products in real-time. The second set of data 524 may correspond to the input data of the one or more products having the second set of parameters.

In some embodiments, the first set of parameters may comprise at least one of quality report data 406, certification data 502, batch record data 402, shipment document data 404, of the one or more products and the plurality of raw materials for each of the one or more products. In some embodiments, the at least one quality report data 406 may comprise at least deviations and non-conformances, change control, complaints, recalls and returns, out of specification (OOS) and out of trend (OOT), corrective and preventive actions (CAPAs), self-inspection, stability, vendor assurance, validation and qualification, quality risk management, and contractual agreements of the one or more products. In some embodiments, the at least one shipment document data 404 may comprise at least supplier information, raw material code, serialization, shipment information, and quality Information of the one or more products. In some embodiments, the at least one batch record data 402 may comprise at least batch identification (ID), production date, serialization information, Stock Keeping Unit (SKU) Code, and batch information records of the one or more products.

In some embodiments, the second set of parameters may comprise the quality report data 530, the certification data 532, the batch record data 526, the shipment document data 528, of the one or more products and the plurality of raw materials for each of the one or more products. In some embodiments, the quality report data 530 may comprise at least deviations and non-conformances, change control, complaints, recalls and returns, out of specification (OOS) and out of trend (OOT), corrective and preventive actions (CAPAs), self-inspection, stability, vendor assurance, validation and qualification, quality risk management, and contractual agreements of the one or more products. In some embodiments, the shipment document data 528 may comprise at least supplier information, raw material code, serialization, shipment information, and quality Information of the one or more products. In some embodiments, the at least one batch record data 526 may comprise at least batch identification (ID), production date, serialization information, Stock Keeping Unit (SKU) Code, and batch information records of the one or more products. Further, the predefined time period may comprise at least one of hours, days, months, quarters, or years in which the first set of data 400 and the second set of data 524 are received.

Further, the operations may comprise correlating each of the first set of parameters of the first set of data 400 with the corresponding the second set of parameters of the second set of data 524 using the trained one or more AI/ML models 512. Further, the operations may comprise predicting the third set of data 534 associated with the one or more products based at least on the correlation using the trained one or more AI/ML models 512. The third set of data 534 may correspond to the correlated first set of data 400 and the second set of data 524. Further, the operations may comprise generating the probability score for the third set of data 534 using the trained one or more AI/ML models 512. The third set of data 534 may comprise information related to the one or more products, the plurality of raw materials for each of the one or more products, and one or more suppliers for each of the plurality of raw materials across the supply chain. Thereafter, the operations may comprise creating at least one supply chain map 500 for the one or more products based at least on the third set of data 534 using the trained one or more AI/ML models 512.

The present disclosure enhances supply chain transparency and visibility by providing a comprehensive overview of product genealogy and supplier relationships, enabling organizations to identify potential bottlenecks or vulnerabilities and optimize the supply chain operations accordingly. Further, by leveraging AI/ML models to correlate real-time data with historical information, the system 100 may facilitate proactive decision-making and risk mitigation, allowing businesses to anticipate and address issues before escalation. Additionally, the predictive capabilities of the AI/ML models may enable the system 100 to forecast future trends, demand fluctuations, and potential supply chain disruptions, in order to make informed strategic decisions and adapt to the operations accordingly. Furthermore, the generation of probability scores for predicted data may enhance decision-making accuracy and confidence, enabling organizations to prioritize resources and interventions effectively. Lastly, the creation of supply chain maps based on the generated data may provide a visual representation of the supply chain ecosystem, facilitating communication, collaboration, and alignment across various stakeholders, ultimately leading to enhanced efficiency, agility, and resilience within the supply chain network.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via at least one processor, a first set of data associated with one or more products over a predefined time period, wherein the first set of data corresponds to a historical data of the one or more products having a first set of parameters;
training, via the at least one processor, one or more artificial intelligence/machine learning (AI/ML) models based at least on the first set of data for the predefined time period;
receiving, via the at least one processor, a second set of data associated with the one or more products in real-time, wherein the second set of data corresponds to an input data of the one or more products having a second set of parameters;
correlating, via the at least one processor, each of the first set of parameters of the first set of data with the corresponding second set of parameters of the second set of data using the trained one or more AI/ML models;
predicting, via the at least one processor, a third set of data associated with the one or more products based at least on the correlation using the trained one or more AI/ML models, wherein the third set of data corresponds to the correlated first set of data and the second set of data;
generating, via the at least one processor, a probability score for the third set of data using the trained one or more AI/ML models, wherein the third set of data comprises information related to the one or more products, a plurality of raw materials for each of the one or more products, and one or more suppliers for each of the plurality of raw materials across a supply chain; and
creating, via the at least one processor, at least one supply chain map for the one or more products based at least on the third set of data using the trained one or more AI/ML models.

2. The method of claim 1, wherein the first set of parameters and the second set of parameters comprise at least one of quality report data, certification data, batch record data, shipment document data, of the one or more products and a plurality of raw materials for each of the one or more products.

3. The method of claim 2, wherein the at least one quality report data comprises at least deviations and non-conformances, change control, complaints, recalls and returns, out of specification (OOS) and out of trend (OOT), corrective and preventive actions (CAPAs), self-inspection, stability, vendor assurance, validation and qualification, quality risk management, and contractual agreements of the one or more products, wherein the at least one shipment document data comprises at least supplier information, raw material code, serialization, shipment information, and quality Information of the one or more products, wherein the at least one batch record data comprises at least batch identification (ID), production date, serialization information, Stock Keeping Unit (SKU) Code, and batch information records of the one or more products.

4. The method of claim 1, wherein the predefined time period comprises at least one of hours, days, months, quarters, or years in which the first set of data and the second set of data are received.

5. The method of claim 1, wherein the one or more trained AI/ML models comprises at least a product raw material Stock Keeping Unit (SKU) tree AI/ML model, a supplier tree AI/ML model, a quality history AI/ML model, a certification tree and audit trail AI/ML model, and a batch traceability AI/ML model.

6. The method of claim 5, wherein the product raw SKU tree AI/ML model comprises one or more data corresponding to a plurality of raw materials for each of the one more products, the supplier tree AI/ML model comprises one or more data corresponding to supplier information for each of the plurality of raw materials, the quality history AI/ML model comprises one or more data corresponding to quality reports of each of the one or more products, the certification tree and audit trail AI/ML model comprises certification data of the one or more products, and the batch traceability AI/ML model comprises one or more data corresponding to batch records of the one or more products.

7. The method of claim 1, wherein the probability score corresponds to a percentage for the plurality of raw materials of each of the one or more products and the one or more suppliers for each of the plurality of raw materials across the supply chain.

8. The method of claim 1 further comprising verifying, via the at least one processor, the probability score generated for the third set of data using the trained one or more AI/ML models, based at least on the first set of data and the second set of data.

9. A system comprising:
a memory; and
at least one processor communicatively coupled to the memory, wherein the at least one processor is configured to:
receive a first set of data associated with one or more products over a predefined time period, wherein the first set of data corresponds to a historical data of one or more products having a first set of parameters;
train one or more artificial intelligence/machine learning (AI/ML) models based at least on the first set of data for the predefined time period;
receive a second set of data associated with the one or more products in real-time, wherein the second set of data corresponds to an input data of the one or more products having a second set of parameters;
correlate each of the first set of parameters of the first set of data with the corresponding the second set of parameters of the second set of data using the trained one or more AI/ML models;
predict a third set of data associated with the one or more products based at least on the correlation, using the trained one or more AI/ML models, wherein the third set of data corresponds to the correlated first set of data and the second set of data;
generate a probability score for the third set of data using the trained one or more AI/ML models, wherein the third set of data comprises information related to the one or more products, a plurality of raw materials for each of the one or more products, and one or more suppliers for each of the plurality of raw materials across a supply chain; and
create at least one supply chain map for the one or more products based at least on the third set of data using the trained one or more AI/ML models.

10. The system of claim 9, wherein the first set of parameters and the second set of parameter comprise at least one of quality report data, certification data, batch record data, shipment document data, of the one or more products and a plurality of raw materials for each of the one or more products.

11. The system of claim 10, wherein the at least one quality report data comprises at least deviations and non-conformances, change control, complaints, recalls and returns, out of specification (OOS) and out of trend (OOT), corrective and preventive actions (CAPAs), self-inspection, stability, vendor assurance, validation and qualification, quality risk management, and contractual agreements of the one or more products, wherein the at least one shipment document data comprises at least supplier information, raw material code, serialization, shipment information, and quality Information of the one or more products, wherein the at least one batch record data comprises at least batch identification (ID), production date, serialization information, Stock Keeping Unit (SKU) Code, and batch information records of the one or more products.

12. The system of claim 9, wherein the predefined time period comprises at least one of hours, days, months, quarters, or years in which the first set of data and the second set of data are received.

13. The system of claim 9, wherein the one or more trained AI/ML models comprises at least a product raw material Stock Keeping Unit (SKU) tree AI/ML model, a supplier tree AI/ML model, a quality history AI/ML model, a certification tree and audit trail AI/ML model, and a batch traceability AI/ML model.

14. The system of claim 13, wherein the product raw SKU tree AI/ML model comprises one or more data corresponding to a plurality of raw materials for each of the one more products, the supplier tree AI/ML model comprises one or more data corresponding to a supplier information for each of the plurality of raw materials, the quality history AI/ML model comprises one or more data corresponding to quality reports of each of the one or more products, the certification tree and audit trail AI/ML model comprises certification data of the one or more products, and the batch traceability AI/ML model comprises one or more data corresponding to batch records of the one or more products.

15. The system of claim 9, wherein the at least one processor is further configured to verify the probability score generated for the third set of data using the trained one or more AI/ML models, based at least on the first set of data and the second set of data, and wherein probability score corresponds to a percentage for the plurality of raw materials of each of the one or more products and the one or more suppliers for each of the plurality of raw materials across the supply chain.

16. A non-transitory machine-readable information storage medium comprising one or more instructions which when executed by at least one processor to perform operations comprising:
receiving a first set of data associated with one or more products over a predefined time period, wherein the first set of data corresponds to a historical data of the one or more products having a first set of parameters;
training one or more artificial intelligence/machine learning (AI/ML) models based at least on the first set of data for the predefined time period;
receiving a second set of data associated with the one or more products in real-time, wherein the second set of data corresponds to an input data of the one or more products having a second set of parameters;
correlating each of the first set of parameters of the first set of data with the corresponding the second set of parameters of the second set of data using the trained one or more AI/ML models;
predicting a third set of data associated with the one or more products based at least on the correlation using the trained one or more AI/ML models, wherein the third set of data corresponds to the correlated first set of data and the second set of data;
generating a probability score for the third set of data using the trained one or more AI/ML models, wherein the third set of data comprises information related to the one or more products, a plurality of raw materials for each of the one or more products, and one or more suppliers for each of the plurality of raw materials across a supply chain; and
creating at least one supply chain map for the one or more products based at least on the third set of data using the trained one or more AI/ML models.

17. The non-transitory machine-readable information storage medium of claim 16, wherein the first set of parameters and the second set of parameters comprise at least one of quality report data, certification data, batch record data, shipment document data, of the one or more products and a plurality of raw materials for each of the one or more products.

18. The non-transitory machine-readable information storage medium of claim 17, wherein the at least one quality report data comprises at least deviations and non-conformances, change control, complaints, recalls and returns, out of specification (OOS) and out of trend (OOT), corrective and preventive actions (CAPAs), self-inspection, stability, vendor assurance, validation and qualification, quality risk management, and contractual agreements of the one or more products, wherein the at least one shipment document data comprises at least supplier information, raw material code, serialization, shipment information, and quality Information of the one or more products, wherein the at least one batch record data comprises at least batch identification (ID), production date, serialization information, Stock Keeping Unit (SKU) Code, and batch information records of the one or more products.

19. The non-transitory machine-readable information storage medium of claim 16, wherein the predefined time period comprises at least one of hours, days, months, quarters, or years in which the first set of data and the second set of data are received.

20. The non-transitory machine-readable information storage medium of claim 16, wherein the one or more trained AI/ML models comprises at least a product raw material Stock Keeping Unit (SKU) tree AI/ML model, a supplier tree AI/ML model, a quality history AI/ML model, a certification tree and audit trail AI/ML model, and a batch traceability AI/ML model.
